(19) United States
(12) Patent Application Publication
(10) Pub. No.: US 2019/0135257 A1
(43) Pub. Date: May 9, 2019

(54) METHODS AND SYSTEMS TO ADAPTIVELY MONITOR BRAKE PAD WEAR

(71) Applicant: GM GLOBAL TECHNOLOGY OPERATIONS LLC, Detroit, MI (US)

(72) Inventors: Nojan Medinei, Toronto (CA); Ali Shabbir, Mississauga (CA); Joseph K. Moore, Whitby (CA)

(21) Appl. No.: 15/802,711

(22) Filed: Nov. 3, 2017

(51) Int. Cl. B60T 17/22; F16D 66/02

(52) U.S. Cl. CPC B60T 17/221; F16D 2066/006; F16D 66/026; F16D 66/022

(57) ABSTRACT

An exemplary method of performing a brake pad wear check includes providing a brake assembly, including a brake pad and a brake rotor, providing a controller electronically connected to the brake assembly, the controller configured to calculate an expected wear of the brake pad, determine a brake pad wear threshold, compare the expected wear of the brake pad to the brake pad wear threshold, and if a first condition is satisfied, perform the brake pad wear check.

### INTRODUCTION

The present invention relates generally to the field of vehicles and, more specifically, to a brake pad wear monitoring system and method.

Vehicles, such as cars, include disc brakes for slowing the rotation of a wheel or another driven component. A disc brake may include a brake pad, a brake caliper, and a brake disc, which is also known as a rotor. The brake disc is operatively connected to the wheel, and the brake caliper is operatively coupled to the brake pad. During operation, the brake caliper can press the brake pad against the brake disc. As a consequence, the friction between the brake pad and the brake disc causes the brake disc (and the wheel attached to the brake disc) to slow or stop.

### SUMMARY

Because the brake pad is subjected to friction during use, the brake pad may wear over time. It is therefore useful to monitor the wear of the brake pad in order to determine when the brake pad is about to reach the end of its life (i.e., when the brake bad should be replaced). Current estimation methods of the remaining brake pad lining life (thickness) rely on physical sensors that wear with the linings, providing feedback of their status. In order to use methods, such as an Electric Park Brake (EPB) Motor on Caliper (MOC), to indirectly measure pad thickness, a strategy to optimize measurement frequency for all customer brake usage profiles is disclosed herein. Also, in some embodiments, intelligent methods may also be used to automatically detect pad changes due to a lack of signals indicating a pad/sensor replacement.

Embodiments according to the present disclosure provide a number of advantages. For example, embodiments according to the present disclosure provide methods to determine remaining brake pad lining material and automatic detection of pad and/or rotor change based on data provided from adaptively sequence test instances of pad thickness measurements.

In one aspect, a method of performing a brake pad wear check includes providing a brake assembly, including a brake pad and a brake rotor and providing a controller electronically connected to the brake assembly. The controller is configured to calculate an expected wear of the brake pad, determine a brake pad wear threshold, compare the expected wear of the brake pad to the brake pad wear threshold, and if a first condition is satisfied, perform the brake pad wear check.

In some aspects, calculating an expected wear of the brake pad includes receiving vehicle usage data.

In some aspects, determining a brake pad wear threshold includes determining a measured brake pad thickness and a time of service of the brake pad.

In some aspects, the controller is further configured to determine whether one or more of the brake pad or the brake rotor has been replaced.

In some aspects, determining whether one or more of the brake pad or the brake rotor has been replaced includes comparing the measured brake pad thickness to an expected change in brake pad thickness.

In some aspects, if the measured brake pad thickness exceeds the expected change in brake pad thickness, the controller is configured to determine a revised brake pad wear threshold.

In some aspects, the first condition is satisfied when the expected wear of the brake pad exceeds the brake pad wear threshold.

In another aspect, a method of performing a brake pad wear check includes the steps of calculating an expected wear of the brake pad, determining a brake pad wear threshold, comparing the expected wear of the brake pad to the brake pad wear threshold, and if a first condition is satisfied, performing the brake pad wear check.

In some aspects, calculating an expected wear of the brake pad includes receiving vehicle usage data.

In some aspects, wherein determining a brake pad wear threshold includes determining an actual brake pad thickness and a time of service of the brake pad.

In some aspects, the method further includes the step of determining whether the brake pad has been replaced by comparing the actual brake pad thickness to an expected change in brake pad thickness.

In some aspects, if the actual brake pad thickness exceeds the expected change in brake pad thickness, the method further includes determining a revised brake pad wear threshold.

In some aspects, the method further includes the steps of determining a first brake pad wear threshold and a second brake pad wear threshold and comparing the expected wear of the brake pad to the first brake pad wear threshold during a first time interval and comparing the expected wear of the brake pad to the second brake pad wear threshold during a second time interval.

In yet another aspect, a system for adaptively performing a brake pad wear check, includes a brake system, including a brake pad and a brake rotor and a controller electronically connected to the brake system. The controller is configured to calculate an expected wear of the brake pad, determine a brake pad wear threshold, compare the expected wear of the brake pad to the brake pad wear threshold, and if a first condition is satisfied, perform the brake pad wear check.

In some aspects, calculating an expected wear of the brake pad includes receiving vehicle usage data.

In some aspects, determining a brake pad wear threshold includes determining a measured brake pad thickness and a time of service of the brake pad.

In some aspects, the controller is further configured to determine whether one or more of the brake pad or the brake rotor has been replaced.

In some aspects, determining whether one or more of the brake pad or the brake rotor has been replaced includes comparing the measured brake pad thickness to an expected change in brake pad thickness.

In some aspects, if the measured brake pad thickness exceeds the expected change in brake pad thickness, the controller is configured to determine a revised brake pad wear threshold.

### BRIEF DESCRIPTION OF THE DRAWINGS

The present disclosure will be described in conjunction with the following figures, wherein like numerals denote like elements.

FIG. 1 is a schematic diagram of a vehicle, according to an embodiment.

FIG. 2 is a block diagram of a system for performing a brake pad wear check, according to an embodiment.

FIG. 3 is a schematic flow diagram of a method for adaptive brake pad wear monitoring, according to an embodiment.

FIG. 4 is a graphical representation of a brake pad wear test sequence and frequency, according to an embodiment.

FIG. 5 is another graphical representation of a brake pad wear test sequence and frequency, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

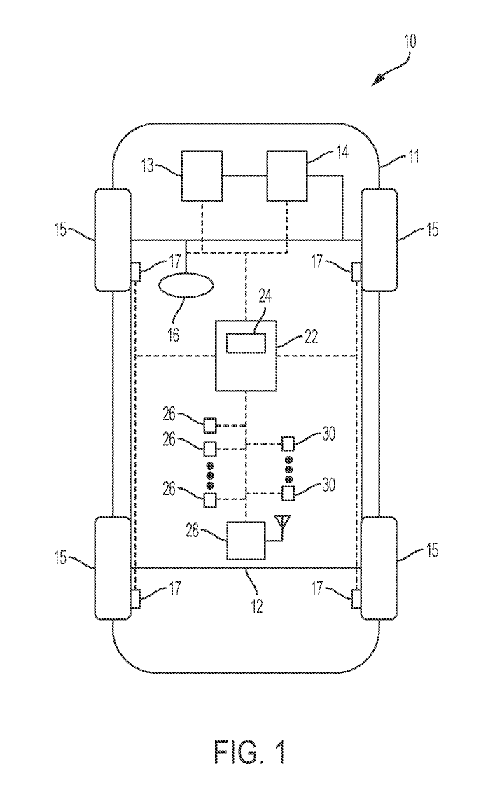

FIG. 1 schematically illustrates an automotive vehicle 10 according to the present disclosure. The vehicle 10 generally includes a body 11, a chassis 12, and wheels 15. The body 11 is arranged on the chassis 12 and substantially encloses the other components of the vehicle 10. The body 11 and chassis 12 may jointly form a frame. The wheels 15 are each rotationally coupled to the chassis 12 near a respective corner of the body 11. The vehicle 10 is depicted in the illustrated embodiment as a passenger car, but it should be appreciated that any other vehicle including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes a brake assembly 17 configured to provide braking torque to the vehicle wheels 15. The brake assembly 17 may, in various embodiments, include friction brakes, a regenerative braking system such as an electric machine, and/or other appropriate braking systems. In some embodiments, the brake assembly 17 is an electromechanical brake assembly that includes at least one brake pad, a brake caliper, a brake rotor, and a drive unit, as disclosed in U.S. patent application Ser. No. 15/220,829, filed Jul. 27, 2016, titled “AN ELECTROMECHANICAL BRAKE SYSTEM AND METHOD,” and incorporated herein by reference in its entirety.

The vehicle 10 additionally includes a steering system 16. In various embodiments, the vehicle 10 also includes a wireless communication system 28. In some embodiments, the wireless communication system 28 includes a navigation system configured to provide location information in the form of GPS coordinates (longitude, latitude, and altitude/elevation) to a controller 22. In some embodiments, the wireless communication system 28 may include a Global Navigation Satellite System (GNSS) configured to communicate with global navigation satellites to provide autonomous geo-spatial positioning of the vehicle 10. In the illustrated embodiment, the wireless communication system 28 includes an antenna electrically connected to a receiver.

With further reference to FIG. 1, the vehicle 10 also includes a sensing system including a plurality of sensors 26 configured to measure and capture data on one or more vehicle characteristics, including but not limited to vehicle speed, vehicle heading, vehicle location, brake pedal travel, brake pedal depression frequency, brake pad thickness, etc. In the illustrated embodiment, the sensors 26 include, but are not limited to, an accelerometer, a speed sensor, a heading sensor, or other sensors that sense observable conditions of the vehicle or the environment surrounding the vehicle and may include RADAR, LIDAR, optical cameras, thermal cameras, ultrasonic sensors, and/or additional sensors as appropriate. The vehicle 10 also includes a plurality of actuators 30 configured to receive control commands to control steering, shifting, throttle, braking, or other aspects of the vehicle 10, as discussed in greater detail below.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle, including the brake assembly 17.

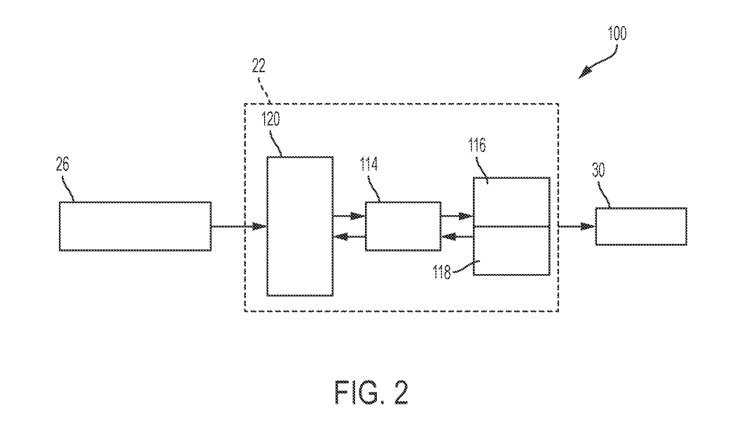

FIG. 2 illustrates an exemplary system 100 for adaptively performing a brake pad wear check. The processor/controller device 22 includes a central processing unit (CPU) 114 coupled to memory devices 116 and 118, which can include such memory as random access memory (RAM) 116, non-volatile read only memory (NVROM) 118, and possibly other mass storage devices. The CPU 114 is coupled through an input/output (I/O) interface 120 to at least one of the plurality of sensors 26, discussed herein with respect to FIG. 1. The sensors 26 are configured to measure various operational parameters of the vehicle and provide data on environmental conditions along a projected path of travel of the vehicle, as discussed herein. In some embodiments, the CPU 114 is coupled through the I/O interface 120 to an inertial measurement unit (IMU) including one or more sensors 26. The controller 22 generates one or more control signals and transmits the control signals to the actuators 30, including, for example and without limitation, one or more actuators 30 configured to control the brake assembly 17.

The brake assembly 17 are to be understood by those skilled in the art as exemplary mechanisms for providing vehicle braking. In some embodiments, the brake assembly 17 includes a mechanism for measuring the thickness of a brake pad and/or rotor to monitor brake pad and/or rotor wear, including, for example and without limitation, an electromechanical parking brake motor on caliper or one or more wear sensors. The methods discussed herein may be used with any brake pad lining measurement technologies including, for example and without limitation, lining wear sensors or the electromechanical brake components discussed herein. The methods for brake pad wear test sequencing discussed herein not limited to the exemplary measurement methods disclosed herein.

As disclosed in U.S. patent application Ser. No. 15/220,829, filed Jul. 27, 2016, titled “AN ELECTROMECHANICAL BRAKE SYSTEM AND METHOD,” and incorporated herein by reference in its entirety, the controller 22 may be programmed to perform periodic brake wear checks contingent upon certain vehicle conditions being met. However, the frequency of performance of the brake wear checks is often determined by the time elapsed or distance traveled since the previous check. These intervals may not optimize the information received from sensors configured to measure brake pad lining thickness or may not fit brake usage profiles for all vehicle operators (for example, a vehicle operated in the mountains may experience more rapid brake pad lining wear than a vehicle operated under highway driving conditions).

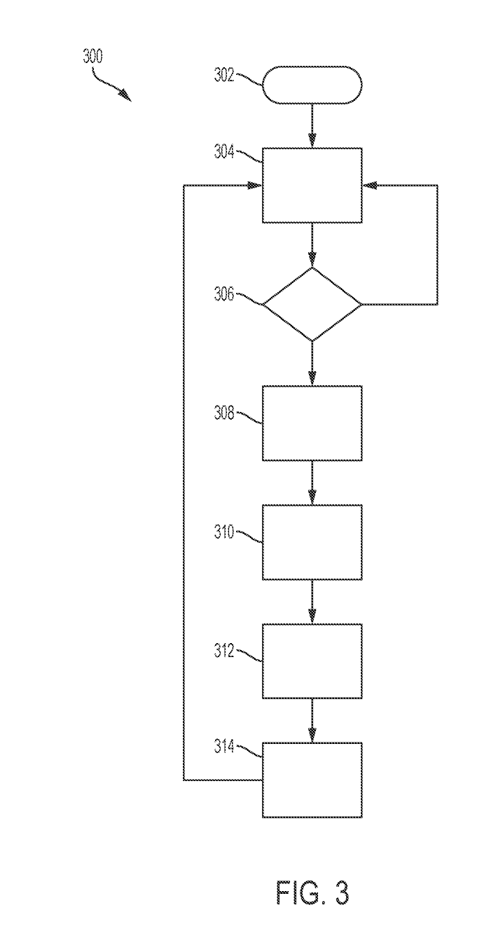

FIG. 3 illustrates a method 300 to adaptively sequence and perform brake pad wear monitoring. The method 300 can be utilized in connection with a vehicle having a brake system and/or brake assembly, such as the vehicle 10. In some embodiments, the method 300 can be utilized in connection with the controller 22 or vehicle electronic control unit (ECU) as discussed herein, or by other systems associated with or separate from the vehicle 20, in accordance with exemplary embodiments. The order of operation of the method 300 is not limited to the sequential execution as illustrated in FIG. 3 but may be performed in one or more varying orders, or steps may be performed simultaneously, as applicable in accordance with the present disclosure.

As shown in FIG. 3, the method 300 starts at 302 and proceeds to 304. At 304, the controller 22 calculates the expected wear of the brake pad of the brake assembly 17. The expected wear calculation, is, in some embodiments, a thermal and/or wear model calculation that provides an estimate of the brake pad thickness. In some embodiments, the expected wear calculation includes information from a variety of vehicle sensors, including, for example and without limitation, vehicle speed, vehicle deceleration rate, brake pedal position, the time elapsed since a previous brake pad wear test, the vehicle mileage since a previous brake pad wear test, etc. to determine a vehicle braking profile. The expected wear calculation is an estimated value of the brake pad thickness based on vehicle usage since the previous test, such as, for example, an electric parking brake motor on caliper (EPB MOC) brake pad wear test. The expected wear calculation provides a base estimate of the brake pad thickness but is supplemented by frequent brake pad thickness measurement tests (such as an EPB MOC brake pad wear test) to provide a more accurate expected wear prediction. Additionally, due to the large number of physical brake pad tests required to achieve a continuous estimate for remaining brake pad life, one or more expected wear calculations since a previously-performed physical brake pad wear test are used to fill the gaps between two consecutive physical brake pad wear tests.

From 304, the method 300 proceeds to 306. At 306, the controller 22 performs an adaptive analysis to optimally time the performance of the brake pad wear test. The controller 22 determines whether the calculated expected wear is greater than or less than a predetermined wear threshold. In some embodiments, the predetermined wear threshold is determined, for example and without limitation, from the vehicle type and brake configuration. If the calculated expected wear is less than the predetermined wear threshold, the method 300 returns to 304. Expected wear calculations may be performed periodically based on, for example and without limitation, time elapsed or mileage traveled since the previous calculation, or may be performed continuously.

However, if the calculated expected wear is greater than the predetermined wear threshold, the method 300 proceeds to 308. At 308, the controller 22 initiates a test to determine the actual brake pad lining thickness. As discussed herein, in some embodiments, the brake pad thickness measurement is an EPB MOC brake pad wear test. In some embodiments, the brake pad thickness is determined from wear sensors or any other brake pad wear measurement mechanism known to those skilled in the art. The brake pad thickness measurement obtained at 308 is an absolute measurement of the brake pad thickness, rather than the estimate calculated at 304. The absolute value of the brake pad thickness is used by the controller 22 to update the estimated brake pad thickness for future expected wear calculations.

From 308, the method 300 proceeds to 310. At 310, the controller 22 resets the accumulated calculated expected wear value (that is, the expected wear calculated since the last physical brake pad thickness measurement) to zero after determining the actual brake pad thickness from the brake pad thickness measurement obtained at 308. The actual wear value determined from the brake pad thickness measurement obtained at 308 is used to correct the calculated expected wear used to inform the vehicle operator of the remaining brake pad life. Resetting the accumulated expected wear calculation to zero avoids the accumulation of calculation error. Additionally, at 310, the controller 22 adaptively modifies the wear threshold based on the measured remaining pad thickness. For example, more frequent brake pad measurements are desired when the brake pad is close to the end of life, that is, the brake pad thickness is small, to more accurately inform the vehicle operator of the expected remaining brake pad life via, for example, a “mileage remaining” until brake service message.

After resetting the calculated expected wear value and modifying the wear threshold, the method 300 proceeds to 312. At 312, the controller 22 calculates a percentage value of brake pad life remaining. In some embodiments, the controller 22 incorporates data from a rotor wear estimation model to generate a more thorough evaluation of the remaining useful life of the brake system.

From 312, the method 300 proceeds to 314. At 314, information relative to the remaining brake pad life may be communicated to the vehicle operator via, for example and without limitation, a vehicle display or any other visual, auditory, or haptic human interface communication method.

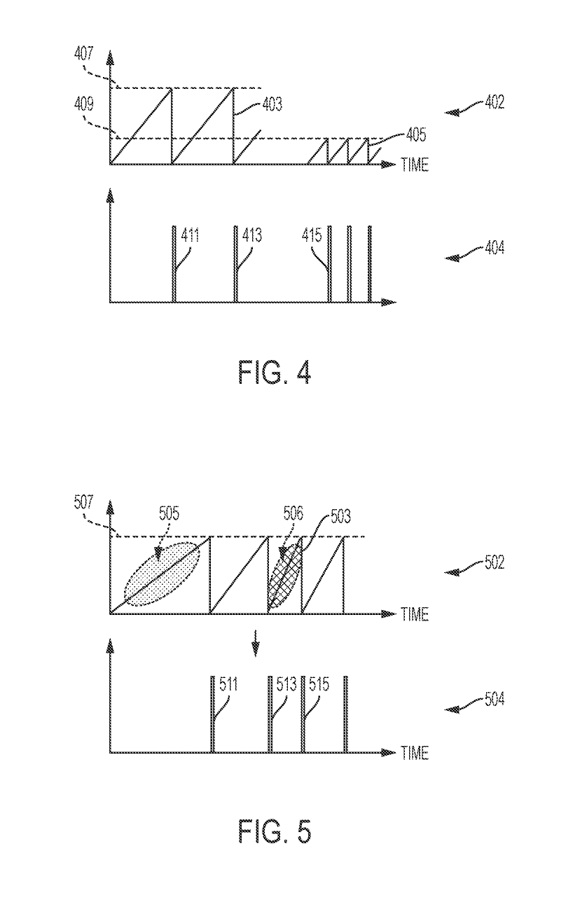

The calculations performed at 304 and 306 are a test sequencing process that determines an optimal interval between brake pad measurement tests, such as those performed in 308. The test sequencing process, as illustrated graphically in FIGS. 4 and 5, incorporates information including, for example and without limitation, the expected brake pad wear, actual brake pad wear, and the vehicle brake usage profile to determine when to perform the brake pad wear measurement test. In some embodiments, the brake pad wear measurement test is performed under specified conditions, such as when the vehicle is stopped, the transmission is in PARK, etc. In some embodiments, the brake pad wear measurement test is performed while the vehicle is moving. Performing frequent brake pad thickness measurements may be an annoyance to the vehicle operator. Therefore, the methods discussed herein optimize the frequency of brake pad measurement tests based on vehicle usage and the estimated brake pad wear.

FIG. 4 graphically illustrates the relationship between the frequency of performance of a brake pad measurement test and the estimated brake pad wear. The graph 402 illustrates the estimated brake pad wear as a function of time. For a new, or lightly used brake pad, the estimated brake pad wear, indicated by line 403, is compared to a first threshold, indicated by line 407. When the estimated brake pad wear 403 approaches or crosses the first threshold 407, a brake pad measurement test is triggered, that is, the controller 22 commands the brake assembly 17 to perform a brake pad measurement test, such as, for example and without limitation an EPB MOC brake pad test.

Graph 404, time-aligned with graph 402, indicates, at 411, that the brake pad measurement test has been triggered at the time the estimated brake pad wear 403 initially reaches the first threshold 407. A subsequent event 413, indicating a second brake pad measurement test, coincides with the second time the estimate brake pad wear 403 reaches the threshold 407. After each brake pad measurement test is triggered and performed, the accumulated estimated brake pad wear is reset to zero to prevent the accumulation of estimation errors and the actual wear value determined from the brake pad thickness measurement is used to correct the calculated expected wear used to inform the vehicle operator of the remaining brake pad life.

In some embodiments, after the brake pad has accumulated wear, an estimated brake pad wear 405 is compared to a second threshold 409. The second threshold 409 represents the estimated brake pad wear near the end of life of the brake pad. In some embodiments, the second threshold 409 is determined by a predetermined time interval, a predetermined vehicle mileage, and/or vehicle usage characteristics, such as, for example and without limitation, driving history, vehicle location, brake pedal travel, brake pedal depression frequency, etc.

When the estimated brake pad wear 405 approaches or crosses the second threshold 409, the brake pad measurement test is triggered. As shown in graph 404, at 415 the brake pad measurement test has been triggered at the time the estimated brake pad wear 405 first reaches the second threshold 409. Subsequent brake pad measurement tests are triggered as the estimated brake pad wear 405 approaches the second threshold 409. As shown in FIG. 4, the frequency of performance of the brake pad wear test increases as the brake pad expected wear approaches an end of life value indicated by the second threshold 409. Thus, the methods discussed herein optimally time the performance of a brake pad wear test such that fewer tests are performed when the brake pad is new or lightly used and the testing frequency increases with the age and usage of the brake pad.

The spacing between the brake pad measurement tests optimally sequences the brake pad measurement test events to more closely correspond to brake pad service intervals. Performance of more frequent brake pad measurement tests based on, for example, a predetermined time or mileage interval, could lead to more frequent test events which may impose on the vehicle operator.

In some embodiments, vehicle brake usage information is used to determine the optimal spacing of brake pad measurement tests. FIG. 5 also graphically illustrates the relationship between the frequency of performance of a brake pad measurement test and the estimated brake pad wear. The graph 502 illustrates the estimated brake pad wear 503 as a function of time. In a first region 505, for a period of time the vehicle is operated at highway speeds with a low frequency of brake applications. During this time, the estimated wear 503 increases slowly (that is has a lower slope) and the time to reach the threshold 507 is greater. As a result, the frequency of brake pad measurement tests is low, as indicated by the spacing between the events 511, 513 in graph 504.

In contrast, a second region 506 illustrates operation of the vehicle with a high frequency of brake application, such as when driving in traffic. During this time, the estimated wear 503 increases more rapidly (that is, the line 503 has a steeper slope) and the time to reach the threshold 507 is smaller. As a result, the frequency of brake pad measurement tests increases, as indicated by the spacing between the events 513, 515 in graph 504.

One of skill in the art should appreciate that the brake pad measurement triggered by information and analysis related to vehicle usage characteristics and the comparison of estimated brake pad wear to one or more thresholds could be performed using any method, including wear sensors, EPB MOC tests, or other measurement methods.

Additionally, in some embodiments, the methods and algorithms discussed herein are used to determine if a brake pad and/or brake rotor has been replaced. For example and without limitation, a brake pad replacement may be detected if the physical brake pad measurement test, such as an EPB MOC brake pad test indicates a measured brake pad thickness significantly higher than a measurement error band, that is, that the measured change in thickness exceeds a threshold expected change in thickness.

Once a brake pad replacement is detected by the physical brake pad measurement test, a comparison between historical vehicle data on the thickness of a new brake pad and new rotor and the actual measured thickness can also indicate a brake rotor replacement. For a vehicle having original equipment brake pad linings, the rotor thickness is expected to be within a calculated range of rotor thicknesses for a new rotor to a worn rotor. If the rotor thickness is not within this range, the actual measurement indicates that the rotor has been replaced.

When either or both of a brake pad replacement and a brake rotor replacement are detected, the methods discussed herein proceed as discussed to adaptively sequence future physical brake pad measurement tests and supplement the measurements obtained from the physical tests with calculated wear data.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a.” “an.” and “the” include plural referents unless the context clearly dictates otherwise Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of performing a brake pad wear check, comprising:
providing a brake assembly, including a brake pad and a brake rotor;
providing a controller electronically connected to the brake assembly, the controller configured to
calculate an expected wear of the brake pad;
determine a brake pad wear threshold;
compare the expected wear of the brake pad to the brake pad wear threshold; and
if a first condition is satisfied, perform the brake pad wear check.

2. The method of claim 1, wherein calculating an expected wear of the brake pad comprises receiving vehicle usage data.

3. The method of claim 1, wherein determining a brake pad wear threshold comprises determining a measured brake pad thickness and a time of service of the brake pad.

4. The method of claim 3, wherein the controller is further configured to determine whether one or more of the brake pad or the brake rotor has been replaced.

5. The method of claim 4, wherein determining whether one or more of the brake pad or the brake rotor has been replaced comprises comparing the measured brake pad thickness to an expected change in brake pad thickness.

6. The method of claim 5, wherein if the measured brake pad thickness exceeds the expected change in brake pad thickness, the controller is configured to determine a revised brake pad wear threshold.

7. The method of claim 1, wherein the first condition is satisfied when the expected wear of the brake pad exceeds the brake pad wear threshold.

8. A method of performing a brake pad wear check, comprising:
calculating an expected wear of a brake pad;
determining a brake pad wear threshold;
comparing the expected wear of the brake pad to the brake pad wear threshold; and
if a first condition is satisfied, performing the brake pad wear check.

9. The method of claim 8, wherein calculating an expected wear of the brake pad comprises receiving vehicle usage data.

10. The method of claim 8, wherein determining a brake pad wear threshold comprises determining an actual brake pad thickness and a time of service of the brake pad.

11. The method of claim 10, further comprising determining whether the brake pad has been replaced by comparing the actual brake pad thickness to an expected change in brake pad thickness.

12. The method of claim 11, wherein if the actual brake pad thickness exceeds the expected change in brake pad thickness, the method further comprises determining a revised brake pad wear threshold.

13. The method of claim 8, further comprising determining a first brake pad wear threshold and a second brake pad wear threshold and comparing the expected wear of the brake pad to the first brake pad wear threshold during a first time interval and comparing the expected wear of the brake pad to the second brake pad wear threshold during a second time interval.

14. A system for adaptively performing a brake pad wear check, comprising:
a brake system, including a brake pad and a brake rotor;
a controller electronically connected to the brake system, the controller configured to
calculate an expected wear of the brake pad;
determine a brake pad wear threshold;
compare the expected wear of the brake pad to the brake pad wear threshold; and
if a first condition is satisfied, perform the brake pad wear check.

15. The system of claim 14, wherein calculating an expected wear of the brake pad comprises receiving vehicle usage data.

16. The system of claim 14, wherein determining a brake pad wear threshold comprises determining a measured brake pad thickness and a time of service of the brake pad.

17. The system of claim 16, wherein the controller is further configured to determine whether one or more of the brake pad or the brake rotor has been replaced.

18. The system of claim 17, wherein determining whether one or more of the brake pad or the brake rotor has been replaced comprises comparing the measured brake pad thickness to an expected change in brake pad thickness.

19. The system of claim 18, wherein if the measured brake pad thickness exceeds the expected change in brake pad thickness, the controller is configured to determine a revised brake pad wear threshold.
